(19) United States
(12) Patent Application Publication
(10) Pub. No.: US 2014/0267667 A1
(43) Pub. Date: Sep. 18, 2014

(54) OUTWARD FACING CAMERA SYSTEM WITH IDENTICAL CAMERA AND EYE IMAGE PICTURE PERSPECTIVE

(71) Applicant: Valve Corporation, Bellevue, WA (US)

(72) Inventor: Jeri Janet Ellsworth, Kirkland, WA (US)

(73) Assignee: Valve Corporation, Bellevue, WA (US)

(21) Appl. No.: 14/201,812

(22) Filed: Mar. 8, 2014

Related U.S. Application Data
(60) Provisional application No. 61/786,008, filed on Mar. 14, 2013.

(51) Int. Cl. H04N 5/232; G06F 3/01

(52) U.S. Cl. CPC H04N 5/23219; G06F 3/013
USPC 348/78

(57) ABSTRACT

Methods and systems relating to providing a mechanism that allows for providing a camera image picture, either still or video, to have the same line of sight as the eye without adding compensation circuitry, or substantial weight, size or power to a heads up display (HUD) for augmented reality applications. The camera may view the same image picture perspective as the eye sees by generating a second image picture view that may have the same line of sight as the eye using a beam splitter to split the incoming view before the image picture is viewed by the eye and the camera. In certain embodiments, after the image picture is split by the beam splitter, the image picture travels towards the eye and towards a camera that is operatively connected to a waveguide so that the image picture may propagate to the camera.

### CROSS-REFERENCE TO RELATED APPLICATIONS

This application claims priority to U.S. Patent Application No. 61/786,008, entitled “Outward Facing Camera System with Identical Camera and Eye Image Picture Perspective,” and filed Mar. 14, 2013. The entirety of the foregoing patent application is incorporated by reference herein.

### BACKGROUND OF THE DISCLOSURE

1. Field of the Disclosure

The disclosure relates generally to methods and systems to obtain an identical line of sight for a camera and for a person's eye allowing for the eye and the camera to view the surroundings from the same image picture perspective and, more specifically according to aspects of certain embodiments, to methods and systems for providing a viewing image picture perspective that may be identical for the eye and a camera using a beam splitter to generate multiple image picture copies and a waveguide for directing the image picture for use in a heads-up display (HUD) for augmented reality applications so as to align the camera image picture perspective to that of the eye and to simplify the alignment process of the camera image capture system.

2. General Background

An outward facing camera for use with a heads-up display (HUD) for augmented reality applications may have a different image picture perspective than a person's eye since it may be in close proximity to the eye, but it may not be in same line of sight as the eye since it may not directly be in front of the eye. The camera may not be in front of the eye since then the camera may be blocking the eye's surrounding landscape. Therefore, the camera may be below the eye, above the eye, to the left of the eye, to the right of the eye, forward of the eye, behind the eye or a combination of these. All of these positions may generate different viewing image picture perspectives and create viewing offsets and issues.

Accordingly, it is desirable to address the limitations in the art. For example, there exists a need to provide for systems and methods that may improve the camera offset issue with no additional complexity, power or weight for heads up display (HUD).

### BRIEF DESCRIPTION OF THE DRAWINGS

By way of example, reference will now be made to the accompanying drawings, which are not to scale.

FIG. 1 depicts an image picture perspective of four objects that may be captured by each eye in accordance with certain embodiments.

FIG. 2 depicts an image picture perspective of four objects that the left eye may capture when the right eye may be closed or blocked in accordance with certain embodiments.

FIG. 3 depicts an image picture perspective of four objects that the right eye may capture when the left eye may be closed or blocked in accordance with certain embodiments.

FIG. 4 depicts an image picture perspective of four objects that may be captured by an eye and by a camera in accordance with certain embodiments.

FIG. 5 depicts an image picture perspective of four objects that may be captured by an eye and by a camera and depicts the difference in terms of a distance and an angle in accordance with certain embodiments.

FIG. 6 depicts an image picture perspective of four objects that may be captured by an eye and by two cameras in accordance with certain embodiments.

FIG. 7 depicts an image picture perspective of four objects that may be captured by an eye and by multiple cameras in various locations in accordance with certain embodiments.

FIG. 8A depicts the operation of certain embodiments of this invention using a beam splitter, a waveguide and a camera.

FIG. 8B depicts a flow chart of certain embodiments of the method using a beam splitter, a waveguide and a camera to allow the camera and the eye to view the same image picture perspective in accordance with certain embodiments.

FIG. 9 depicts a typical beam splitter that may split an incident signal into two signals in accordance with certain embodiments.

FIG. 10 depicts the operation of certain embodiments of this invention using a beam splitter, waveguides, a coupling device and a camera.

FIG. 11 depicts the operation of certain embodiments of this invention using a camera systems and a projector system.

FIG. 12 depicts the operation of certain embodiments of this invention using a CPU and sensor information overlaid on the image picture, to create an augmented reality display.

FIG. 13 depicts a flow chart of certain embodiments of this invention using a CPU and sensor information overlaid on the image picture, to create an augmented reality display in accordance with certain embodiments.

FIG. 14 is an exemplary diagram of a computing device 1400 that may be used to implement aspects of certain embodiments of the present invention.

### DETAILED DESCRIPTION

Those of ordinary skill in the art will realize that the following description of the present invention is illustrative only and not in any way limiting. Other embodiments of the invention will readily suggest themselves to such skilled persons, having the benefit of this disclosure. Reference will now be made in detail to specific implementations of the present invention as illustrated in the accompanying drawings. The same reference numbers will be used throughout the drawings and the following description to refer to the same or like parts.

In certain embodiments, methods and systems are disclosed relating to providing a mechanism that may allow for providing a camera image picture, either still or video to have the same line of sight as the eye while adding less compensation circuitry, less weight, less size and less power to a heads up display (HUD) for augmented reality applications. The camera may view the same image picture perspective as the eye sees by generating a second image picture view that may have the same line of sight as the eye by using a beam splitter to split the incoming view before the image picture may be viewed by the eye and a camera. After the image picture is split by the beam splitter, the image picture may travel towards the eye and towards a camera that may be operatively connected to a waveguide so that the image picture may propagate to the camera. Other aspects and advantages of various aspects of the present invention can be seen upon review of the figures and of the detailed description that follows.

In certain embodiments an image capture system for capturing pictures with the same line of sight as an eye is disclosed including a beam splitter for splitting an incident image picture into at least a first image copy for transmission to an eye and a second image copy for transmission to an image capture device, and a waveguide for transmitting the second image copy from the beam splitter to the image capture device. In certain embodiments, the image capture system may include a projector, and a second waveguide for transmitting an image from the projector to the eye. In certain embodiments, the image capture device may be operatively connected to the projector. In certain embodiments, the image capture device may be operatively connected to a processor, which may be operatively connected to the projector. In certain embodiments, the processor may be configured for providing processor overlay information and an image copy to the projector for projecting the image picture. The overlay information may include at least one of processor data, sensor data and other image data.

In certain embodiments, an image capture system for capturing an image picture with the same line of sight as an eye is disclosed including a beam splitter having at least two output ports for splitting an incident image into at least two image copies, a waveguide operatively connected to a first output port, and an image capture device operatively connected to the waveguide for receiving a first image copy from the waveguide. A second output port may be configured for transmitting a second image copy to an eye. In certain embodiments, the image capture system may further includes a projector, and a second waveguide for transmitting an image from the projector to the eye. The image capture device may be operatively connected to the projector. In certain embodiments, the image capture device may be operatively connected to a processor, which may be operatively connected to the projector. In certain embodiments, the processor may be configured for providing processor overlay information and an image copy to the projector for projecting the image picture. The overlay information may include at least one of processor data, sensor data and other image data.

In certain embodiments, a method for capturing pictures with the same line of sight as an eye is disclosed including splitting an incident image picture into at least a first image copy for transmission to an eye and a second image copy for transmission to an image capture device, and transmitting the second image copy from the beam splitter through a waveguide to the image capture device. In certain embodiments, the method further may include providing a projector, and transmitting an image from the projector through a second waveguide to the eye. In certain embodiments, the method further may include operatively connecting the image capture device to the projector. In certain embodiments, the method further may include operatively connecting the image capture device to a processor, and further operatively connecting the processor to the projector. In certain embodiments, the processor may be configured for providing processor overlay information and an image copy to the projector for projecting the image picture. The overlay information may include at least one of processor data, sensor data and other image data.

The difference in image picture perspective between what the eye sees and what the camera sees may be compensated for so that the camera and the eye may have the same image picture perspective for augmented reality applications. One solution may be that the image picture from the camera may be compensated through the use of a compensation circuit that may correct the viewing image picture perspective for any differences between the viewing image picture perspectives of the eye and the camera.

FIG. 1 depicts a system 100 illustrating a difference in image picture perspective with respect to a person's eyes. Each person's eyes, the left eye 110, and the right eye 120, have two different lines of sight 170 and 180. These lines of sight both see a different image picture perspective of the surroundings. For example, object 130 may be between the left eye 110 and another object 150, and between the right eye 120 and object 140. Even though objects 140 and 150 are not in the direct line of sight of the left eye 110 or right eye 120, the eyes may see all four of these objects in front of the eyes, because each of the three other objects shown, 140, 150 and 160, is visible to either the left eye 110, the right eye 120, or both.

FIG. 2 depicts a system 200 in which the right eye 220 may be closed or blocked. This shows that not all four of the objects may be seen anymore. Now only three objects may be seen. The objects that may be viewed may be objects 230, 240 and 260. The left eye 210 may not see the object 250, since the object 230 may be blocking it. FIG. 2 depicts one negative impact a difference in image picture perspective may make with respect to a person's eyes.

Taking another image picture perspective as an example, FIG. 3 depicts a system 300 in which the left eye 310 may be closed or blocked. This shows that all four of the objects may not be seen anymore. Now a different set of three objects may be seen. These may be objects 330, 350 and 360. The right eye 320 may not be able to see the object 340 since it may be being blocked by object 330. FIG. 3 depicts one negative impact a difference in image picture perspective may make with respect to a person's eyes.

The eyes may see all four objects when both eyes may be open because the human brain automatically compensates for the eyes showing different image picture perspectives and blends what both eyes see into one viewable image picture. The human brain may compensate for different viewable image picture perspectives and calculate what to blend together for these two image picture perspectives into one image picture. To correct for a difference in viewing image picture perspective, the human brain may be presented two viewable image picture perspective image pictures separately, one from the left eye and one from the right eye. These image pictures may then be combined or blended within the human brain to give the perception of one viewable image picture so that all four objects can be seen.

FIG. 4 shows a Heads Up Display (HUD) camera system 400 of the prior art. The camera 420 may be offset from the eye 410 and generate another image picture perspective 480 that may be different than from the eye's image picture perspective 470. FIG. 4 depicts a difference in image picture perspective with respect to a person's eye 410 and to a head mounted camera 420. An eye 410 and camera 420 may have two different lines of sight 470 and 480 respectively. These lines of sight both see a different image picture perspective of the world. For example, if an object 430 is between the eye 410, and the camera 420 and the three other objects shown, 440, 450 and 460, the eye 410 and the camera 420 may have different viewing image picture perspectives. The eye 410 may see objects 430, 440, and 460 whereas the camera 420 may only see objects 430, 450, and 460. This difference in viewing image picture perspective may be compensated for since the eye 410 sees a different image picture perspective than the camera 420. This may be an issue since the different image picture perspectives may show a different angle view and show different objects within each of their viewing image picture perspectives.

This difference in viewing image picture perspective may be measured in terms of distance and angles. FIG. 5 illustrates a system 500 in which a distance measurement 555 and an angle offset θ 565 are among the differences between the two viewing image picture perspectives. This distance measurement 555 and the angle θ 565 may be used to compensate for this image picture perspective offset and generate a camera image picture with the same image picture perspective as the eye 510. A camera image picture can be any type of picture such as a video stream, a still picture, a sequence of still pictures, etc. However, shifting the image picture perspective of the camera 520 to the image picture perspective of the eye 510 may not solve the problem fully. It may solve the issue of shifting the angle of viewing image picture perspective to be the same as the eye 510, but it may not solve the issue of objects in the image picture scene being blocked. The camera compensation circuit 590 may not be able to fix this issue since the camera may never have captured these blocked objects. So if the display image picture perspective is shifted by using a camera compensation circuit 590, there may still be objects that may be missing from the picture frames. The camera compensation circuit may be used to calculate and correct for the offset in the viewpoints, but may not correct for blocked objects since they may be simply unknown. For instance, the image picture perspective of the camera 580 may be corrected but object 540 that may be blocked by object 530 may not be able to be corrected for since there may be no other camera to take another image picture perspective for comparison.

In certain embodiments, the two cameras may be used to solve the issue of blocking objects. FIG. 6 depicts a system 600 using two cameras 620 and 625 for taking pictures. Pictures may be a video stream, still pictures, a sequence of still pictures, etc. The use of two cameras 620 and 625 may generate two different viewable image picture perspectives 680 and 685. By having knowledge of the distances 655 and 658 and the angles θ₁ 668 and θ₂ 665, a compensation circuit 690 may generate correction factors that may be used to merge the two camera image pictures into a single image that may have the same image picture perspective as the eye's image picture perspective 670. By adding multiple cameras to a head mounted display (HUD) it may add more complexity to the HUD, more weight to the HUD, a larger HUD may be needed to fit all of these components, and may add more power drain to a power source, e.g., battery.

To change the camera image picture perspective there may need to be even more offset data collected than the angles θ1 668 and θ2 665 and the distances 655 and 658. Also, the camera position may be in other positions other than to the left or to the right of the eye 610. The camera may also be at a particular distance below the eye 610, a particular distance above the eye 610, a particular distance to the left of the eye 610, a particular distance to the right of the eye 610, a particular distance forward of the eye 610, or a particular distance behind the eye 610 or any combination of these. These offsets all generate different image picture perspectives that may need to be compensated for with a compensation circuit 690.

FIG. 7 depicts a few of these different possible image picture perspectives. FIG. 7 depicts a camera 725 to the right of the eye 710 at a particular distance 727 and a camera 770 to the left of the eye 710 at a particular distance 772. Each of these cameras may be shifted forward of the eye 710 or behind the eye 710. Cameras 780 and 785 may be cameras behind the eye 710, whereas cameras 720 and 777 may be cameras that may be forward of the eye 710. The cameras 785 and 780 behind the eye 710 have a different set of image picture perspectives then the cameras 720 and 777 that may be forward of the eye 710. Each of these image picture perspectives has its own set of distances and angles that may need to be used in calculating the correct amount of compensation for the viewable image picture perspective to generate a picture with the same image picture perspective 790 as the eye 710.

To allow for the camera to generate an image picture that may contain the same viewable image picture perspective as the eye and contains all the image picture content that the eye may view, complexity to create the same viewable image picture perspective for the camera image picture may need to be added to the heads up display (HUD), as well as the addition of the weight of more components, as well as the HUD assembly may need to be larger for the addition of the components, and more power may need to be added to the (HUD) to power the additional circuitry needed.

FIG. 8A illustrates an image capture system 800 for capturing pictures with the same line of sight as an eye according to certain embodiments of this invention. FIG. 8A illustrates an image picture perspective view of an image picture that may have an identical line of sight 830 for a camera 835 and for a person's eye 810 allowing the eye 810 and the camera 835 to view the surroundings from the same image picture perspective. In certain embodiments, the image capture system 800 may include a camera 835, a beam splitter 840 and a waveguide 845 for use in a heads-up display (HUD) for augmented reality applications so as to align the camera 835 image picture perspective to that of the eye 810. As illustrated in FIG. 8A, beam splitter 840 is in the line of sight 830 of eye 810. In certain embodiments, system 800 may reduce complexity of any required compensation and may simplify picture calculations for the offset of the camera.

In certain embodiments, the flow chart of FIG. 8B depicts a method 850 of operating image capture system 800. The method 850 includes using a beam splitter 840, a waveguide 845 and a camera 835 to allow the camera 835 and the eye 810 to view the same image picture perspective (855). An incident beam representative of the viewable image picture perspective may enter the beam splitter 840 and split into two signals (860). The first signal 825 that may be output from a first port of the beam splitter 840 may travel to the eye 810 (865) while the second signal 826 may be output from the second port of the beam splitter 840 and may travel towards a camera 835 along waveguide 845 (870). A first port of the waveguide 845 is coupled to the second port of the beam splitter 840 and the second port of the waveguide 845 is coupled to a camera 835 (via waveguide 845) connecting a path from the viewable image picture perspective to the camera capture system 875. The camera 835 captures the signal from the second port of waveguide 845 (875) that has the same image picture perspective as the eye 810. Therefore it is understood that the invention is not to be limited to the specific embodiments disclosed, and that modifications and embodiments are intended to be included as readily appreciated by those skilled in the art.

FIG. 9 depicts a beam splitter 910 that may be used in certain embodiments including that shown in FIG. 8A. A beam splitter 910 may be an optical device that splits an incident beam 920 of light into two beams. In certain embodiments, the beam splitter 910 may have a rectangular shape made from two triangular glass prisms 950 and 960, which may be glued together at their base 915 using polyester, epoxy, or urethane-based adhesives. The thickness of the resin layer may be adjusted such that, for a certain wavelength, half of the light incident 920 through one input port 980 such as the face of the cube may be reflected to a first output port 940 and the other half may be transmitted to a second port 930.

There may be many ways to build a beam splitter 910, including but not limited to a Polarizing beam splitters, called a Wollaston prism, that may split light into beams of differing polarization. In certain embodiments, a half-silvered mirror may be used as a beam splitter. This may be a plate of glass with a thin coating of aluminum, which may be deposited from aluminum vapor, with the thickness of the aluminum coating such that a portion of the light incident at a 45-degree angle may be transmitted, and the remainder reflected. In certain embodiments, the portion of light transmitted may be approximately half of the incident light. Instead of a metallic coating, a dielectric optical coating may also be used. Therefore, it is understood that the invention is not to be limited to the specific embodiments disclosed, and that modifications and embodiments are intended to be included as readily appreciated by those skilled in the art.

Waves in open space propagate in all directions. In this way, they lose their power proportionally to the square of the distance; that may be at a distance R from the source, the power may be the source power divided by R². A waveguide 845 confines the wave to propagation in one dimension, so that under ideal conditions the wave loses no power while propagating. Waves may be confined inside the waveguide due to total reflection from the waveguide wall, so that the propagation inside the waveguide can be described approximately as a “zigzag” between the walls. This description may be exact for electromagnetic waves in a hollow metal tube with a rectangular or circular cross section. By using a waveguide 845, a projection of an image picture coming from the beam splitter may be channeled to another location as depicted in FIG. 8A into the camera 835.

Referring back to FIGS. 8A and 8B, in certain embodiments, a first output port 940 of beam splitter 900 is coupled to eye 810 and second output port 930 may be coupled to waveguide 845, which in turn may be coupled to an input port of camera 835. Thus, the same signal is input to both the eye 810 (865) and camera 835 (870).

In certain embodiments, FIG. 10 illustrates an image capture system 1000 for capturing pictures with the same line of sight as an eye according to certain embodiments of this invention. Image capture system 1000 may be similar to image capture system 800 depicted in FIG. 8A, except that it may include an additional waveguide coupled to the waveguide coupled to the beam splitter. Image capture system 1000 may be useful to channel a projection of an image picture of the surroundings coming from the beam splitter 1080 may be channeled to other locations other than just to the right or just to the left of the eye 1010. In certain embodiments, a waveguide 1090 may be coupled to another waveguide 1095 by using a coupling device 1085 such as a mirror. In certain embodiments, the image picture may be projected down waveguide 1090 from the beam splitter 1080 and then using coupling device 1085, the image picture may be coupled to another waveguide 1095 and into camera 1035. This arrangement may allow for the camera 1035 to be able to be positioned anywhere near or on the heads up display (HUD) to a particular distance below the eye 1010, including but not limited to a particular distance above the eye 1010, a particular distance to the left of the eye 1010, a particular distance to the right the eye 1010, a particular distance forward of the eye 1010, or a particular distance behind the eye 1010 or any combination of these. These camera position offsets may generate identical image picture perspectives that may not need to be compensated with a compensation circuit. Therefore, it is understood that the invention is not to be limited to the specific embodiments disclosed, and that modifications and embodiments are intended to be included as readily appreciated by those skilled in the art. In certain embodiments, FIG. 11 illustrates an image capture system 1100 for capturing pictures with the same line of sight as an eye according to certain embodiments of this invention. Image capture system 1100 may be similar to image capture system 800 depicted in FIG. 8A, except that it may include two waveguides 1180 and 1190 coupled to the beam splitter 1182, and a lens placed in front of eye 1110. In certain embodiments, waveguide 1190 may be coupled to the camera 1135, and waveguide 1180 may be coupled to projector 1170. Projector 1170 (via waveguide 1180) projects an image picture 1165 onto lens 1160 placed in front of the eye 1110. The lens 1160 may have incident on it both the surrounding image picture view 1130 and a projection view image picture 1165 from projector 1170. In certain embodiments, the projection image picture view 1165 may include or be representative of information generated by central processing unit (CPU) 1175. In some embodiments, the information may include without limitation text data (e.g., a user-specified tag or label), graphics data, video data, temperature data, humidity data, altitude data, other sensor data, etc. The information projected onto the lens 1160 from the projector 1170 may be generated by a CPU system 1175 that may be operatively coupled to the projector 1170 and that may include a (i) user interface for receiving one or more of the information projected onto lens 1160, and/or (ii) interface to sensors 1176 for sensing such information as temperature, humidity, altitude etc., and generating sensor data. Data from sensors 1176 and/or user data is input to CPU 1175 so that such information as text data, graphics data, video data, temperature data, humidity data, altitude data, other sensor data, etc. may be projected out of the projector 1170 and be overlaid onto the camera picture 1130. This augmented picture may then be sent through the waveguide 1180 and onto the lens 1160 so that the eye 1110 may now see the surroundings with augmented data overlaid onto it for use in a heads-up display (HUD) for augmented reality applications.

FIG. 11 also shows that an image picture perspective view 1130 of the surroundings may have an identical line of sight 1130 for a camera 1135 and for a person's eye 1110 allowing the eye 1110 and the camera 1135 to view the surroundings from the same image picture perspective. The image picture perspective view 1130 may use a beam splitter 1182 coupled to a first port of a waveguide 1190 and having a second port of the waveguide 1190 coupled to the camera 1135 for use in a heads-up display (HUD) for augmented reality applications so as to align the camera 1135 image picture perspective 1130 to that of the eye 1110. Therefore, it is understood that the invention is not to be limited to the specific embodiments disclosed, and that modifications and embodiments are intended to be included as readily appreciated by those skilled in the art.

In certain embodiments, FIG. 12 illustrates an image capture system 1200 for capturing pictures with the same line of sight as an eye according to certain embodiments of this invention. Image capture system 1200 may be similar to image capture system 1100 depicted in FIG. 12, except that it may include an occluding device 1245 to occlude signal 1232 coming from the beam splitter 1282 from the lens 1260 and therefore the eye 1210.

In certain embodiments, FIG. 12 depicts an image picture perspective view of an image picture 1230 of the surroundings that may have an identical line of sight 1230 for a camera 1235 and for a person's eye 1210 allowing the eye 1210 and the camera 1235 to view the surroundings from the same image picture perspective 1230. The image picture perspective 1230 may use a use a beam splitter 1282 coupled to a first port of a waveguide 1290 and may have the second port of the waveguide 1290 coupled to the camera 1235 for guiding the image picture perspective view into the camera. In certain embodiments, the image picture perspective view 1232 coming from the beam splitter 1282 may be occluded, or in other words blocked, from the lens 1260 and therefore the eye 1210. The occluding device 1245 may be coupled to a CPU 1275 and may be controlled by the CPU 1275 to block the image picture perspective image picture view 1232 from beam splitter 1282 using the occluding device 1245. In some embodiments, CPU 1275 may also be coupled to both the camera 1235 and the projector 1270, while in other embodiments the camera 125 and projector 1270 may be coupled to separate processors.

FIG. 13 depicts a flow chart of a method 1300 for using a CPU and sensor information overlaid on the image picture, to create an augmented reality display according to certain embodiments. Method 1300 begins with generating of an incident signal representative of viewable image picture perspective 1230 (1305). The incident signal may be split into two signals using beam splitter (1310). The first signal 1232 that may be output from the first port of the beam splitter may be occluded (1315), or in other words blocked, from the eye 1210. In certain embodiments, CPU (e.g., CPU 1275) may generate a control signal to control occlusion of the image picture perspective view. If the signal is not occluded, the first signal 1232 may then travel to the eye 1210 (1320).

In certain embodiments, a second signal may be output from the second port of the beam splitter 1282 and may travel towards a camera 1235 along a waveguide 1290 (1325). An input port of the waveguide 1290 may be coupled to the second output port of the beam splitter 1282 and an output port of the waveguide 1290 may be coupled to a camera 1235. The second signal from the beam splitter 1282 may be output from the second output port of the beam splitter 1282 and travel towards the camera 1235 through the waveguide 1290. The camera 1235 may capture the signal (1330) that has the same image picture perspective as the eye 1210. An output interface of the camera 1235 may transmits a camera output signal to a CPU 1275 (1340). The CPU 1275 overlays overlay data on the camera output signal (1360). In some embodiments, overlay data includes CPU-generated data 1350 such as text, graphics and video and may overlay it onto the output of the camera signal 1360. In some embodiments, overlay data includes data that may be collected by sensors 1276 or data indicative thereof (1365). In some embodiments, overlay data may include user-specified data, such as user-specified text.

The combined camera output signal and overlay data may be input into the projector 1270 (1370). The projector 1270 may then project the combined signal towards the eye 1210 through a waveguide 1280 (1380). The system may now show the surroundings with augmented data overlaid onto it for use in a heads-up display (HUD) for augmented reality applications. Therefore, it is understood that the invention is not to be limited to the specific embodiments disclosed, and that modifications and embodiments are intended to be included as readily appreciated by those skilled in the art.

FIG. 14 is an exemplary diagram of a computing device 1400 that may be used to implement aspects of certain embodiments of the present invention, such as aspects of CPU 1275. Computing device 1400 may include a bus 1401, one or more processors 1405, a main memory 1410, a read-only memory (ROM) 1415, a storage device 1420, one or more input devices 1425, one or more output devices 1430, and a communication interface 1435. Bus 1401 may include one or more conductors that permit communication among the components of computing device 1400. Processor 1405 may include any type of conventional processor, microprocessor, or processing logic that interprets and executes instructions. Main memory 1410 may include a random-access memory (RAM) or another type of dynamic storage device that stores information and instructions for execution by processor 1405. ROM 1415 may include a conventional ROM device or another type of static storage device that stores static information and instructions for use by processor 1405. Storage device 1420 may include a magnetic and/or optical recording medium and its corresponding drive. Input device(s) 1425 may include one or more conventional mechanisms that permit a user to input information to computing device 1400, such as a keyboard, a mouse, a pen, a stylus, handwriting recognition, voice recognition, biometric mechanisms, and the like. Output device(s) 1430 may include one or more conventional mechanisms that output information to the user, including a display, a projector, an A/V receiver, a printer, a speaker, and the like. Communication interface 1435 may include any transceiver-like mechanism that enables computing device/server 1400 to communicate with other devices and/or systems. Computing device 1400 may perform operations based on software instructions that may be read into memory 1410 from another computer-readable medium, such as data storage device 1420, or from another device via communication interface 1435. The software instructions contained in memory 1410 cause processor 1405 to perform processes that will be described later. Alternatively, hardwired circuitry may be used in place of or in combination with software instructions to implement processes consistent with the present invention. Thus, various implementations are not limited to any specific combination of hardware circuitry and software.

While the above description contains many specifics and certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art, as mentioned above. The invention includes any combination or subcombination of the elements from the different species and/or embodiments disclosed herein.

We claim:

1. An image capture system for capturing pictures with the same line of sight as an eye comprising:
a beam splitter for splitting an incident image picture into at least a first image copy for transmission to an eye and a second image copy for transmission to an image capture device; and
a waveguide for transmitting the second image copy from the beam splitter to the image capture device.

2. The image capture system of claim 1, further comprising:
a projector; and
a second waveguide for transmitting an image from the projector to the eye.

3. The image capture system of claim 2, wherein the image capture device is operatively connected to the projector.

4. The image capture system of claim 2, wherein the image capture device is operatively connected to a processor.

5. The image capture system of claim 4, wherein the processor is operatively connected to the projector.

6. The image capture system of claim 5, wherein the processor is configured for providing processor overlay information and an image copy to the projector for projecting said image picture.

7. The image capture system of claim 6, wherein said overlay information includes at least one of processor data, sensor data and other image data.

8. An image capture system for capturing an image picture with the same line of sight as an eye, comprising:
a beam splitter having at least two output ports for splitting an incident image into at least two image copies;
a waveguide operatively connected to a first output port;
an image capture device operatively connected to the waveguide for receiving a first image copy from the waveguide; and
wherein a second output port is configured for transmitting a second image copy to an eye.

9. The image capture system of claim 8, further comprising:
a projector; and
a second waveguide for transmitting an image from the projector to the eye.

10. The image capture system of claim 9, wherein the image capture device is operatively connected to the projector.

11. The image capture system of claim 9, wherein the image capture device is operatively connected to a processor.

12. The image capture system of claim 11, wherein the processor is operatively connected to the projector.

13. The image capture system of claim 12, wherein the processor is configured for providing processor overlay information and an image copy to the projector for projecting said image picture.

14. The image capture system of claim 13, wherein said overlay information includes at least one of processor data, sensor data and other image data.

15. A method for capturing pictures with the same line of sight as an eye comprising:
splitting an incident image picture into at least a first image copy for transmission to an eye and a second image copy for transmission to an image capture device; and
transmitting the second image copy from the beam splitter through a waveguide to the image capture device.

16. The method of claim 15, further comprising:
providing a projector; and
transmitting an image from the projector through a second waveguide to the eye.

17. The method of claim 16, further comprising operatively connecting the image capture device to the projector.

18. The method of claim 16, further comprising operatively connecting the image capture device to a processor.

19. The method of claim 18, further comprising operatively connecting the processor to the projector.

20. The method of claim 19, wherein the processor is configured for providing processor overlay information and an image copy to the projector for projecting said image picture.

21. The method of claim 20, wherein said overlay information includes at least one of processor data, sensor data and other image data.
